(19) United States
(12) Patent Application Publication
(10) Pub. No.: US 2024/0340036 A1
(43) Pub. Date: Oct. 10, 2024

(54) MOBILE PHONE CASE HAVING ELECTRONIC KEY

(71) Applicant: Shenzhen Yunrui IOT Technology Co., Ltd., Shenzhen (CN)

(72) Inventor: Haicheng Luo, Dongguan (CN)

(21) Appl. No.: 18/131,930

(22) Filed: Apr. 7, 2023

(51) Int. Cl. H04B 1/3888

(52) U.S. Cl. CPC H04B 1/3888

(57) ABSTRACT

Provided is a mobile phone case having an electronic key. The mobile phone case includes a case main body and the electronic key, where a containing groove is provided in one side of the case main body, and a position clamping groove is provided in a bottom plate of the containing groove. The electronic key is embedded in the position clamping groove of the case main body, and the electronic key can be protected and stored by means of the case main body, thereby avoiding loss of the electronic key. A detachable connection manner is configured between the electronic key and the position clamping groove of the case main body, such that when the electronic key needs to be used or replaced, only the electronic key needs to be taken down from the case main body, which further improves convenience of the mobile phone case in use.

### TECHNICAL FIELD

The present invention relates to the technical field of electronic keys, and in particular to a mobile phone case having an electronic key.

### BACKGROUND ART

A traditional electronic key, such as an electronic key of an automobile, an electric vehicle, a motorcycle or an electronic door, etc., has no fixed storage position due to a small volume, such that after a user completes use of the electronic key, the electronic key is usually put aside at will, which is likely to cause loss of the electronic key, and causes great inconvenience to the user.

### SUMMARY

In order to solve the problem that an electronic key is likely to be lost due to no fixed storage position, which causes great inconvenience to a user, an example of the present invention provides a mobile phone case having an electronic key.

In order to solve the above technical problem, the example of the present invention provides a mobile phone case having an electronic key. The mobile phone case includes a case main body and the electronic key, where a containing groove for containing a mobile phone is provided in one side of the case main body, a position clamping groove matching the electronic key is provided in a bottom plate of the containing groove, and the electronic key is detachably embedded in the position clamping groove.

Preferably, one of the electronic key and the position clamping groove is provided with a clamping convex eave, the other of the electronic key and the position clamping groove is provided with a clamping groove corresponding to the clamping convex eave in position and matching the clamping convex eave, and the electronic key is in clamping connection to the position clamping groove by means of the clamping convex eave and the clamping groove.

Preferably, the position clamping groove penetrates the case main body, the electronic key is further provided with a control button, and the control button is arranged on the side away from the containing groove.

Preferably, a depth of the position clamping groove is greater than or equal to a thickness of the electronic key.

Preferably, the side, away from the containing groove, of the electronic key is flush with the side, away from the containing groove, of the position clamping groove.

Preferably, the side, away from the containing groove, of the position clamping groove is further provided with a rib, the rib protrudes from the case main body and is arranged in an enclosed manner to form a protective groove, and the side, away from the containing groove, of the electronic key is flush with the protective groove.

Preferably, the electronic key is further provided with a fool-proof device, and the fool-proof device cooperates with the position clamping groove to prevent reverse mounting of the electronic key.

Preferably, two opposite sides of the clamping convex eave are provided with a first arc-shaped chamfer and a second arc-shaped chamfer with different radii respectively, the clamping groove is further provided with a first clamping angle corresponding to the first arc-shaped chamfer and a second clamping angle corresponding to the second arc-shaped chamfer, and when the electronic key is clamped in the position clamping groove, the first arc-shaped chamfer is arranged at the first clamping angle, and the second arc-shaped chamfer is arranged at the second clamping angle.

Preferably, the electronic key is further provided with a magnetic attraction member, the position clamping groove is further provided with a magnetic member corresponding to the magnetic attraction member, and the electronic key is in magnetic attraction connection to the position clamping groove by means of the magnetic attraction member and the magnetic member.

Preferably, the electronic key is any one of an electronic vehicle key, an electric door key, and an electronic lock key.

Compared with the prior art, the mobile phone case having an electronic key provided by the example of the present invention has the following advantages:
1. According to the mobile phone case provided by the example of the present invention, a plurality of functions are integrated into a whole, the mobile phone may be protected by the case main body, an automobile may be controlled by means of the electronic key, and relatively high practicability is achieved. Moreover, the electronic key is embedded in the position clamping groove of the case main body, and the electronic key may be protected and stored by means of the case main body, thereby avoiding loss of the electronic key. Moreover, the electronic key may be also carried by a user only by carrying the mobile phone equipped with the mobile phone case, thereby avoiding forgetting and loss of the electronic key. A detachable connection manner is configured between the electronic key and the position clamping groove of the case main body, such that when the electronic key needs to be used or replaced by the user, only the electronic key needs to be taken down from the case main body, which further improves convenience of the mobile phone case in use, and has relatively high promotion value.
2. According to the example of the present invention, the electronic key is in clamping connection to the clamping groove by means of the clamping convex eave, the clamping connection manner is more convenient for mounting and dismounting the electronic key, and moreover, the clamping convex eave and the clamping groove are simple in structure and convenient to machine and manufacture. Furthermore, the clamping groove cooperates with the clamping convex eave, such that the electronic key may be prevented from falling off from the position clamping groove, and stability and firmness of the electronic key during mounting are further ensured.
3. According to the example of the present invention, the control button of the electronic key is arranged on the side away from the containing groove. It may be understood that the control button of the electronic key may be exposed out of the case main body as the position clamping groove penetrates the case main body. During use, the user does not need to disassemble the electronic key from the case main body, the corresponding device may be controlled by directly pressing the control button, and therefore, the convenience of the mobile phone case during use is further improved.
4. According to the example of the present invention, the depth of the position clamping groove is greater than or equal to the thickness of the electronic key, and when the electronic key is embedded in the position clamping groove, the electronic key does not protrude from the position clamping groove. It may be understood that when the mobile phone is mounted in the containing groove, the electronic key embedded in the position clamping groove does not interfere with the mobile phone, thereby further ensuring smoothness of the mobile phone during mounting.
5. According to the example of the present invention, the side, away from the containing groove, of the electronic key is flush with the side, away from the containing groove, of the position clamping groove, which may be understood that when the user takes the mobile phone case, the flush surface is smoother and more comfortable, thereby further improving comfort when the user takes the mobile phone case. Moreover, the flush outer surface is more beautiful, thereby further improving beauty of the mobile phone case.
6. According to the example of the present invention, the side, away from the containing groove, of the electronic key is flush with the protective groove, which may be understood that since the protective groove protruding out of the case main body is more convenient for a user to perform recognition, the protective groove may be recognized only by touching, such that the electronic key may be quickly found, and the convenience of the mobile phone case during use is further improved. Moreover, the side, away from the containing groove of the electronic key is flush with the protective groove, such that the electronic key may be protected by the protective groove, the electronic key is prevented from being damaged by external force, and a service life of the electronic key is further prolonged.
7. When the electronic key provided by the example of the present invention is clamped in the position clamping groove, the first arc-shaped chamfer is arranged at the first clamping angle, and the second arc-shaped chamfer is arranged at the second clamping angle. It may be understood that since the radius of the first arc-shaped chamfer and the radius of the second arc-shaped chamfer are different, when the first arc-shaped chamfer is placed at the second clamping angle or the second arc-shaped chamfer is placed at the first clamping angle, the electronic key fails to be clamped in the position clamping groove, and therefore, the uniqueness of mounting orientation of the electronic key is ensured by setting the arc-shaped chamfers with different radii, reverse mounting of the electronic key is avoided, and dismounting and mounting by the user are facilitated.
8. Detachable connection is achieved between the electronic key and the position clamping groove which are provided by the example of the present invention in a magnetic attraction manner, the magnetic member and the magnetic attraction member are simple in structure, high in interchangeability and convenient to machine and manufacture, and later maintenance and replacement are facilitated.
9. The electronic key provided by the example of the present invention is any one of the electronic vehicle key, the electric door key and the electronic lock key, and the user may select different types of electronic keys according to specific use conditions, thereby further improving selectivity of the electronic key in the mobile phone case.

### BRIEF DESCRIPTION OF THE DRAWINGS

FIG. 1 is schematic diagram 1 of a three-dimensional structure of a mobile phone case provided by example 1 of the present invention.

FIG. 2 is exploded schematic diagram 1 of a mobile phone case provided by example 1 of the present invention.

FIG. 3 is an enlarged schematic diagram of portion A in FIG. 2.

FIG. 4 is an enlarged schematic diagram of portion B in FIG. 2.

FIG. 5 is exploded schematic diagram 2 of a mobile phone case provided by example 1 of the present invention.

FIG. 6 is an enlarged schematic diagram of portion C in FIG. 5.

FIG. 7 is a schematic structural diagram of an electronic key of a mobile phone case provided by example 1 of the present invention.

FIG. 8 is a schematic structural diagram of a case main body of a mobile phone case provided by example 1 of the present invention.

FIG. 9 is schematic diagram 2 of a three-dimensional structure of a mobile phone case provided by example 1 of the present invention.

FIG. 10 is an enlarged schematic diagram of portion D in FIG. 9.

FIG. 11 is schematic diagram 3 of a three-dimensional structure of a mobile phone case provided by example 1 of the present invention.

FIG. 12 is an exploded schematic diagram of an electronic key of a mobile phone case provided by example 1 of the present invention.

### DESCRIPTION OF REFERENCE NUMERALS

1, mobile phone case;
11, case main body; 12, electronic key;
111, containing groove; 112, position clamping groove; 121, clamping convex eave; 122, magnetic attraction member; 123, housing; 124, circuit board; 125, battery;
1111, bottom plate; 1112, side wall; 1114, camera through hole; 1115, key through hole; 1121, clamping groove; 1122, first clamping angle; 1123, second clamping angle; 1124, rib; 1125, protective groove; 1126, magnetic member; 1211, first arc-shaped chamfer; 1212, second arc-shaped chamfer; and 1231, control button.

### DETAILED DESCRIPTION OF THE EMBODIMENTS

For making the objectives, technical solutions and advantages of the present invention clearer, the present invention will be described in further detail below in conjunction with the accompanying drawings and examples. It should be understood that the particular examples described herein are merely illustrative of the present invention and are not intended to limit the present invention.

It should be noted that the terms of “first”, “second”, etc. in the description and claims of the present invention are used for distinguishing different subjects instead of being used for describing a specific order.

It should be noted that when an element is described to be “fixed” to another element, the element may be located directly on another element or there may be an intermediate element. When an element is considered to be “connected” to another element, the element may be directly connected to another element or there may be an intermediate element simultaneously. The terms of “vertical”, “horizontal”, “left”, “right” and similar expressions used herein are just for illustrative purposes.

In the present invention, the orientation or positional relationships indicated by the terms of “up”, “down”, “left”, “right”, “front”, “rear”, “top”, “bottom”, “inner”, “outer”, “middle”, “vertical”, “horizontal”, “transverse”, “longitudinal”, etc. are orientation or positional relationships shown in the drawings. These terms are primarily intended to better describe the present invention and the examples thereof, and are not intended to limit the indicated devices, elements or components to have to have particular orientations, or be constructed and operated in particular orientations.

Moreover, in addition to being used for indicating orientation or positional relationships, the above-mentioned partial terms may also be used to indicate other meanings, for example, the term “on” may also be used to represent a certain attachment relationship or connection relationship in some cases. The specific meanings of these terms in the present invention can be understood on a case-by-case basis for those of ordinary skill in the art.

In addition, the terms of “mounting”, “arranging”, “providing”, “connection” and “connecting” should be understood broadly. For example, they may be a fixed connection, a detachable connection, or integrated construction; may be a mechanical connection, or an electrical connection; and may be a direct connection, or an indirect connection via an intermediate medium, or communication inside two devices, elements or components. The specific meanings of the above terms in the present invention may be understood on a case-by-case basis for those of ordinary skill in the art.

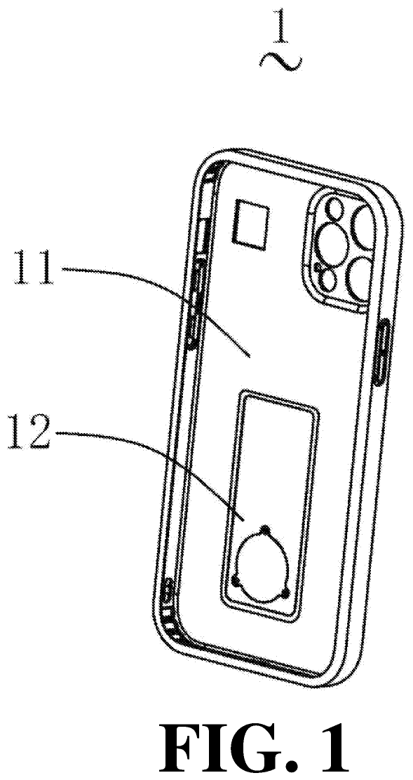

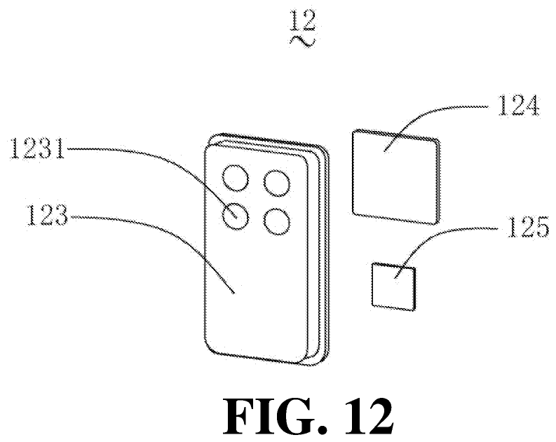

With reference to FIG. 1 and FIG. 12, example 1 of the present invention provides a mobile phone case 1 having an electronic key. The mobile phone case 1 includes a case main body 11 and the electronic key 12, and the electronic key 12 is arranged on the case main body 11 and is detachably connected to the case main body 11.

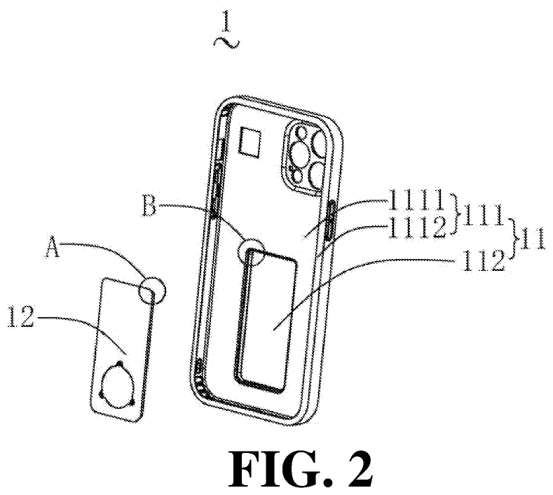

With reference to FIG. 1 and FIG. 2, specifically, one side of the case main body 11 is provided with a containing groove 111 for containing a mobile phone, the containing groove 111 has a bottom plate 1111 and a side wall 1112 protruding along the bottom plate 1111, and the side wall 1112 is arranged in a circumferential direction of the bottom plate 1111 and forms the containing groove 111 together with the bottom plate 1111. The bottom plate 1111 of the containing groove 111 is further provided with a position clamping groove 112 matching the electronic key 12, and the electronic key 12 is detachably embedded in the position clamping groove 112.

It may be understood that by mounting the case main body 11 on the mobile phone, protection of the mobile phone may be achieved, the mobile phone is prevented from being damaged by external force, and the electronic key 12 embedded in the position clamping groove 112 may control a corresponding electronic device. The above two functions are integrated into a whole by means of the mobile phone case 1, a user may also carry the electronic key 12 only by carrying the mobile phone equipped with the mobile phone case 1, such that forgetting of the electronic key 12 is avoided, and practicability of the mobile phone case 1 is further improved. Meanwhile, the electronic key 12 is embedded in the position clamping groove 112 of the case main body 11, and the electronic key 12 may be protected and stored by means of the case main body 11, thereby avoiding loss of the electronic key 12. A detachable connection manner is configured between the electronic key 12 and the position clamping groove 112, such that when the electronic key 12 needs to be used or replaced by the user, only the electronic key 12 needs to be taken down from the case main body 11, which further improves convenience of the mobile phone case 1 in use, and has relatively high promotion value.

Types of the electronic key 12 is not specifically limited in the example of the present invention. Optionally, the electronic key 12 may be any one of an electronic vehicle key, an electric door key, and an electronic lock key. Specifically, the electronic key 12 in the example of the present invention is the electronic vehicle key. It may be understood that different electronic devices correspond to different types of electronic keys 12. The example of the present invention provides various types of electronic keys 12, such that the user may select the corresponding electronic key 12 according to the specific electronic device, thereby further improving optionality of the electronic key 12 in the mobile phone case 1.

A shape of the electronic key 12 is not specifically limited in the example of the present invention, as long as the electronic key 12 may be embedded in the position clamping groove 112. Preferably, the shape of the electronic key 12 is any one of a circle, a square, a square-like shape, a triangle, a triangle-like shape, a polygon, a polygon-like shape, and a racetrack. Specifically, the electronic key 12 in the example of the present invention is in a rectangle-like shape. The position clamping groove 112 is a rectangle-like position clamping groove matching the electronic key 12.

A shape of the case main body 11 is not specifically limited in the example of the present invention, and the shape of the case main body 11 may be set according to a specific shape of the mobile phone. As one embodiment, in the example of the present invention, the case main body 11 has a rectangle-like shape and is provided with a transition fillet.

According to the example of the present invention, the detachable connection manner between the electronic key 12 and the position clamping groove 112 is not specifically limited. A detachable connection between the electronic key 12 and the position clamping groove 112 may be achieved in a clamping manner, the detachable connection between the electronic key 12 and the position clamping groove 112 may also be achieved in a magnetic attraction manner, and the detachable connection between the electronic key 12 and the position clamping groove 112 may also be achieved in a bonding manner.

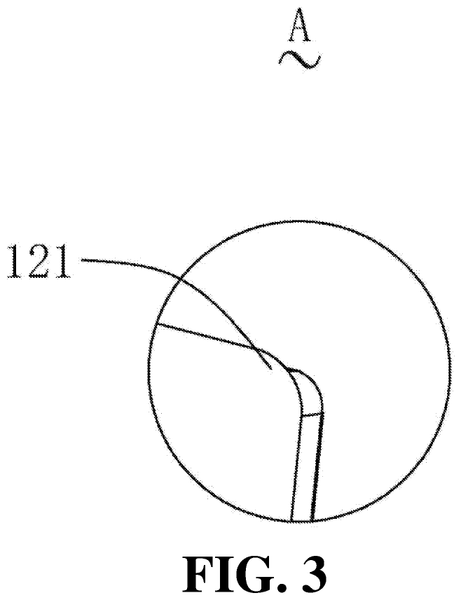

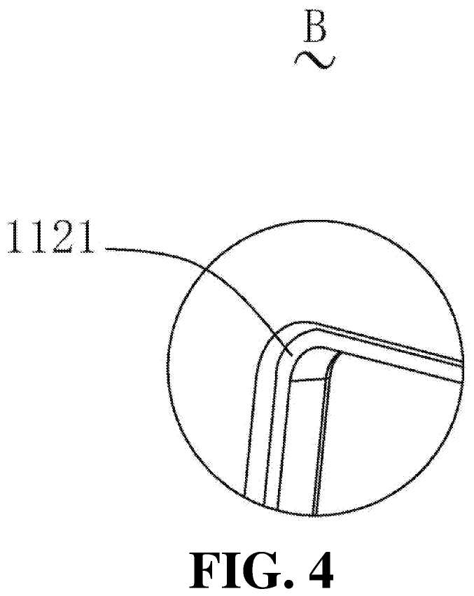

With reference to FIGS. 2-4, as one embodiment, the detachable connection between the electronic key 12 and the position clamping groove 112 may be achieved in the clamping manner. Specifically, one of the electronic key 12 and the position clamping groove 112 is provided with a clamping convex cave, the other of the electronic key 12 and the position clamping groove 112 is provided with a clamping groove corresponding to the clamping convex cave in position and matching the clamping convex eave, and the electronic key 12 is in clamping connection to the position clamping groove 112 by means of the clamping convex cave and the clamping groove. More specifically, a peripheral side of the side, close to the containing groove 111, of the electronic key 12 is provided with the clamping convex eave 121. The position clamping groove 112 is provided with the clamping groove 1121 corresponding to the clamping convex eave 121 in position and matching the clamping convex eave 121, and the electronic key 12 is in clamping connection to the clamping groove 1121 by means of the clamping convex eave 121. It may be understood that the electronic key 12 and the position clamping groove 112 are connected in the clamping manner, which facilitates mounting and dismounting of the electronic key 12. Moreover, the clamping convex cave 121 and the clamping groove 1121 are simple in structure and convenient to machine and manufacture. Furthermore, the clamping groove 1121 cooperates with the clamping convex eave 121, such that the electronic key 12 may be prevented from falling off from the position clamping groove 112, and stability and firmness of the electronic key 12 during mounting are further ensured.

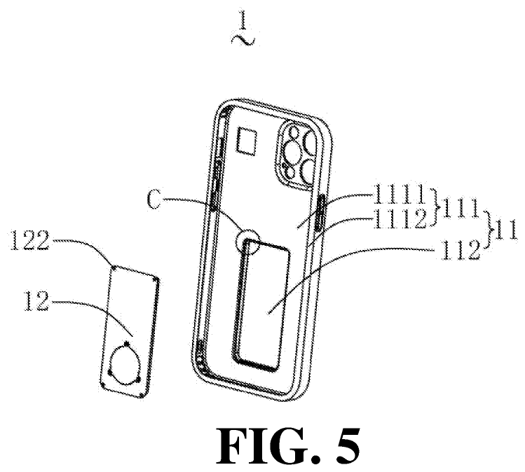

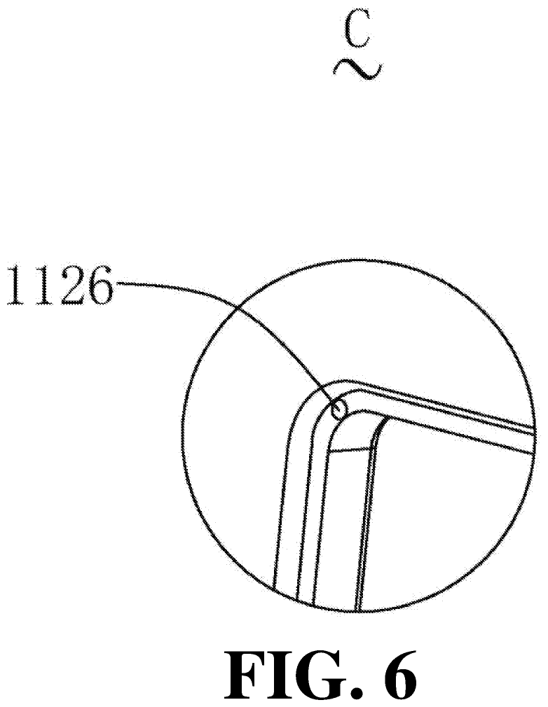

With reference to FIG. 5 and FIG. 6, as another embodiment, the detachable connection between the electronic key 12 and the position clamping groove 112 may be achieved in the magnetic attraction manner. Specifically, the electronic key 12 is further provided with a magnetic attraction member 122, the position clamping groove 112 is further provided with a magnetic member 1126 corresponding to the magnetic attraction member 122, and the electronic key 12 is in magnetic attraction connection to the position clamping groove 112 by means of the magnetic attraction member 122 and the magnetic member 1126. It may be understood that the magnetic member 1126 and the magnetic attraction member 122 are simple in structure and convenient to machine and manufacture. Moreover, the magnetic member 1126 and the magnetic attraction member 122 have high interchangeability, which facilitates later maintenance and replacement.

The mounting position of the magnetic attraction member 122 on the electronic key 12 and the mounting position of the magnetic member 1126 on the position clamping groove 112 are not specifically limited in the example of the present invention, and the mounting positions may be adjusted according to a specific use condition. When the position clamping groove 112 penetrates the case main body 11, the magnetic attraction member 122 may be arranged on a side wall of the electronic key 12, and the magnetic member 1126 is arranged on an inner wall of the position clamping groove 112 and corresponds to the magnetic attraction member 122, and when the position clamping groove 112 does not penetrate the case main body 11, the mounting position of the magnetic attraction member 122 on the electronic key 12 only needs to correspond to the mounting position of the magnetic member 1126 on the position clamping groove 112.

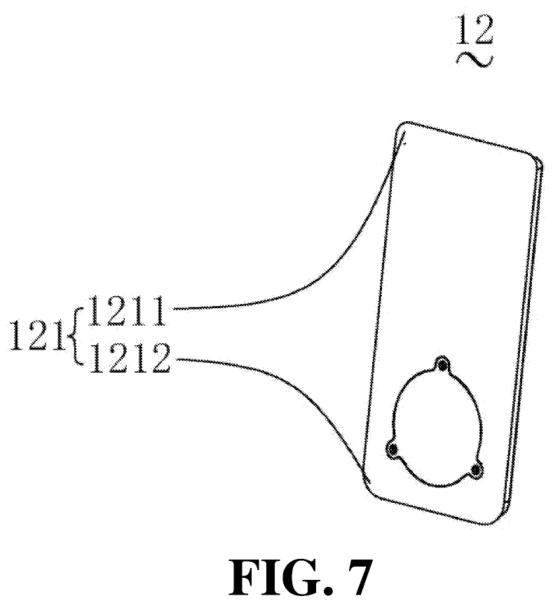

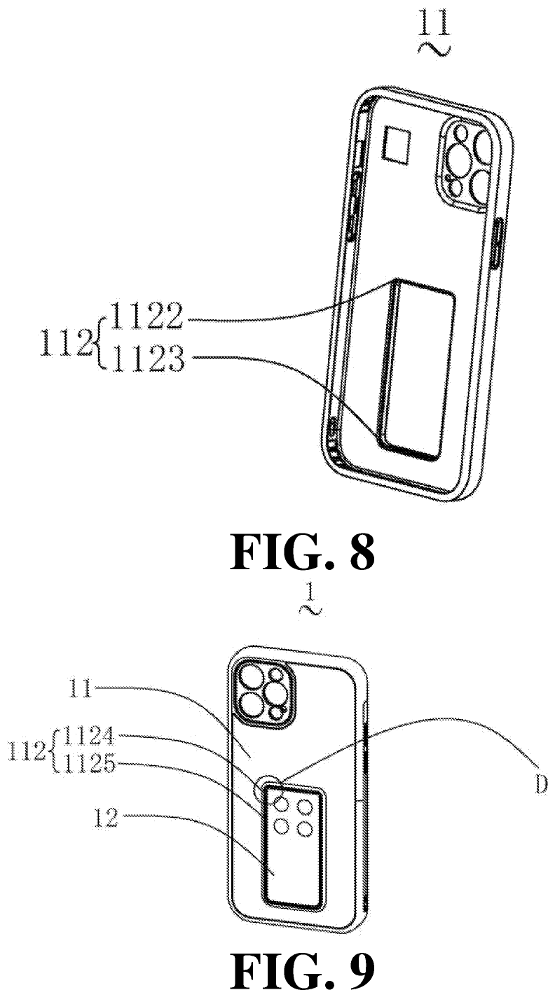

With reference to FIG. 7 and FIG. 8, in order to ensure accuracy of the mounting position of the electronic key 12 when the electronic key 12 is embedded in the position clamping groove 112, the electronic key 12 is further provided with a fool-proof device, and the fool-proof device cooperates with the position clamping groove 112 to prevent reverse mounting of the electronic key 12.

Specifically, in the example of the present invention, the fool-proof device are of a first arc-shaped chamfer 1211 and a second arc-shaped chamfer 1212 which are arranged on two opposite sides of the clamping convex cave 121, and the radii of the first arc-shaped chamfer 1211 and the second arc-shaped chamfer 1212 are different. The clamping groove 1121 is further provided with a first clamping angle 1122 corresponding to the first arc-shaped chamfer 1211 and a second clamping angle 1123 corresponding to the second arc-shaped chamfer 1212. When the electronic key 12 is clamped in the position clamping groove 112, the first arc-shaped chamfer 1211 is arranged at the first clamping angle 1122, and the second arc-shaped chamfer 1212 is arranged at the second clamping angle 1123. It may be understood that when the electronic key 12 is mounted in a reverse direction, the first arc-shaped chamfer 1211 is arranged at the second clamping angle 1123, and the second arc-shaped chamfer 1212 is arranged at the first clamping angle 1122, since the radii of the first arc-shaped chamfer 1211 and the second arc-shaped chamfer 1212 are different, the first arc-shaped chamfer 1211 fails to be clamped at the second clamping angle 1123, the second arc-shaped chamfer 1212 fails to be clamped at the first clamping angle 1122, and in this case, the electronic key 12 fails to be embedded in the position clamping groove 112.

It may be understood the electronic key 12 is provided with the arc-shaped chamfers with different radii to form the fool-proof device, such that the uniqueness of the mounting direction of the electronic key 12 is ensured, reverse mounting of the electronic key 12 is avoided, and multiple times of dismounting and mounting by the user are facilitated.

Furthermore, in order to prevent the electronic key 12 from interfering with the mobile phone, a depth of the position clamping groove 112 in the example of the present invention is greater than or equal to a thickness of the electronic key 12. It may be understood that since the depth of the position clamping groove 112 is greater than or equal to the thickness of the electronic key 12, when the electronic key 12 is embedded in the position clamping groove 112, the electronic key 12 does not protrude from the position clamping groove 112 and does not protrude from the containing groove 111, the mobile phone is mounted in the containing groove 111, and therefore, the electronic key 12 embedded in the position clamping groove 112 does not interfere with the mobile phone, thereby further ensuring the smoothness of the mobile phone during mounting, and also preventing the electronic key 12 from being in contact with the mobile phone to scratch the mobile phone.

Furthermore, a depth of the portion, in the case main body 11, of the position clamping groove 112 is not specifically limited in the example of the present invention, the position clamping groove 112 may penetrate the case main body 11, and the position clamping groove 112 may also be a groove in the case main body 11. As one embodiment, the position clamping groove 112 of the example of the present invention penetrate the case main body 11.

It may be understood that since the position clamping groove 112 penetrates the case main body 11 and the electronic key 12 is embedded in the position clamping groove 112, the side, away from the containing groove 111, of the electronic key 12 may be exposed by means of the position clamping groove 112. In order to protect the side, away from the containing groove 111, of the electronic key 12, the position clamping groove 112 is further provided with a rib.

With reference to FIG. 2 and FIG. 9, specifically, the side, away from the containing groove 111, of the position clamping groove 112 is further provided with the rib 1124, and the rib 1124 protrudes from the case main body 11 and is arranged in an enclosed manner to form a protective groove 1125. The side, away from the containing groove 111, of the electronic key 12 is flush with the protective groove 1125.

It may be understood that since the protective groove 1125 protruding out of the case main body 11 is more convenient for a user to perform recognition, the protective groove 1125 may be recognized only by touching, such that the electronic key 12 may be quickly found, and the convenience of the mobile phone case 1 during use is further improved. Moreover, the side, away from the containing groove 111, of the electronic key 12 is flush with the protective groove 1125, such that the electronic key 12 may be protected by the protective groove 1125, the electronic key 12 is prevented from being damaged by external force, and a service life of the electronic key 12 is further prolonged.

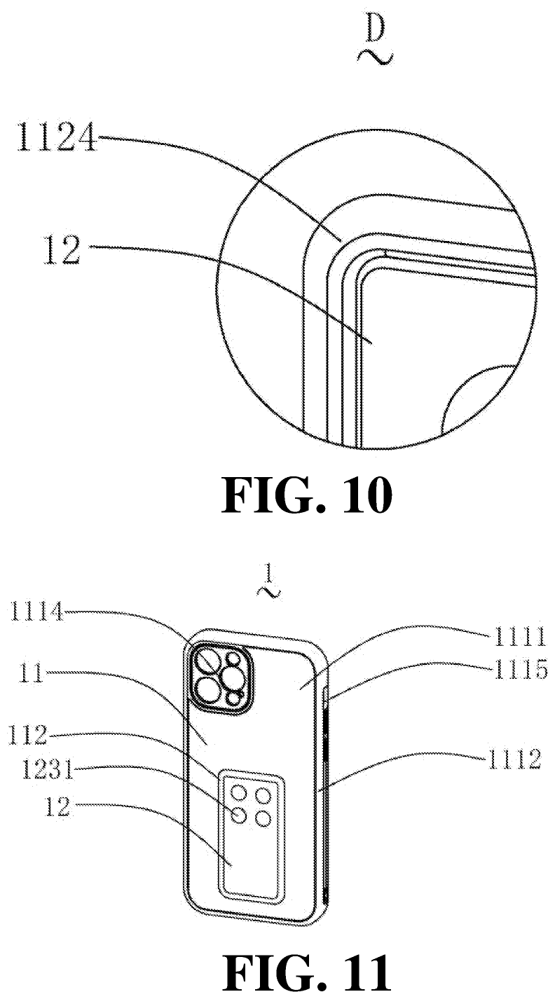

With reference to FIG. 2 and FIG. 10, as another embodiment, the position clamping groove 112 may not be provided with a rib, the side, away from the containing groove 111, of the electronic key 12 is flush with the side, away from the containing groove 111, of the position clamping groove 112, and the electronic key 12 is directly protected by means of the position clamping groove 112. It may be understood that the position clamping groove 112 is not provided with the rib, such that the side, away from the containing groove 111, of the position clamping groove 112 is flush with an outer surface of the case main body 11. When the user takes the mobile phone case 1, the flush surface is smoother and more comfortable, thereby further improving comfort when the user takes the mobile phone case 1. Moreover, the flush outer surface is more beautiful, thereby further improving beauty of the mobile phone case 1.

With reference to FIG. 10, furthermore, in order to further improve the convenience of the case main body 11 during use, the case main body 11 is further provided with a camera through hole 1114 corresponding to a mobile phone camera and a key through hole 1115 corresponding to a mobile phone functional key. The camera through hole 1114 is arranged at the bottom plate 1111, and the key through hole 1115 is arranged on the side wall 1112. Certainly, if the mobile phone is not provided with the above-mentioned functional key, the case main body 11 may also not be provided with a corresponding key through hole 1115, which is not specifically limited in the present invention.

With reference to FIG. 10 and FIG. 11, furthermore, the electronic key 12 further includes a housing 123, a circuit board 124, and a battery 125. The battery 125 is electrically connected to the circuit board 124, the battery and the circuit board are both arranged in the housing 123, a control area of the housing 123 corresponding to the circuit board 124 is further provided with a flexible control button 1231, and the control button 1231 is arranged on the side away from the containing groove 111.

It may be understood that since the position clamping groove 112 penetrates the case main body 11, the control button 1231 of the electronic key 12 may be exposed out of the case main body 11 by means of the position clamping groove 112. During use, the user does not need to disassemble the electronic key 12 from the case main body 11, an electronic device may be controlled by directly pressing the control button 1231, and therefore, the convenience of the mobile phone case 1 during use is further improved.

Compared with the prior art, the mobile phone case having an electronic key provided by the example of the present invention has the following advantages:
1. According to the mobile phone case provided by the example of the present invention, a plurality of functions are integrated into a whole, the mobile phone may be protected by the case main body, an automobile may be controlled by means of the electronic key, and relatively high practicability is achieved. Moreover, the electronic key is embedded in the position clamping groove of the case main body, and the electronic key may be protected and stored by means of the case main body, thereby avoiding loss of the electronic key. Moreover, the electronic key may be also carried by a user only by carrying the mobile phone equipped with the mobile phone case, thereby avoiding forgetting and loss of the electronic key. A detachable connection manner is configured between the electronic key and the position clamping groove of the case main body, such that when the electronic key needs to be used or replaced by the user, only the electronic key needs to be taken down from the case main body, which further improves convenience of the mobile phone case in use, and has relatively high promotion value.
2. According to the example of the present invention, the electronic key is in clamping connection to the clamping groove by means of the clamping convex eave, the clamping connection manner is more convenient for mounting and dismounting the electronic key, and moreover, the clamping convex cave and the clamping groove are simple in structure and convenient to machine and manufacture. Furthermore, the clamping groove cooperates with the clamping convex eave, such that the electronic key may be prevented from falling off from the position clamping groove, and stability and firmness of the electronic key during mounting are further ensured.
3. According to the example of the present invention, the control button of the electronic key is arranged on the side away from the containing groove. It may be understood that the control button of the electronic key may be exposed out of the case main body as the position clamping groove penetrates the case main body. During use, the user does not need to disassemble the electronic key from the case main body, the corresponding device may be controlled by directly pressing the control button, and therefore, the convenience of the mobile phone case during use is further improved.
4. According to the example of the present invention, the depth of the position clamping groove is greater than or equal to the thickness of the electronic key, and when the electronic key is embedded in the position clamping groove, the electronic key does not protrude from the position clamping groove. It may be understood that when the mobile phone is mounted in the containing groove, the electronic key embedded in the position clamping groove does not interfere with the mobile phone, thereby further ensuring smoothness of the mobile phone during mounting.
5. According to the example of the present invention, the side, away from the containing groove, of the electronic key is flush with the side, away from the containing groove, of the position clamping groove, which may be understood that when the user takes the mobile phone case, the flush surface is smoother and more comfortable, thereby further improving comfort when the user takes the mobile phone case. Moreover, the flush outer surface is more beautiful, thereby further improving beauty of the mobile phone case.
6. According to the example of the present invention, the side, away from the containing groove, of the electronic key is flush with the protective groove, which may be understood that since the protective groove protruding out of the case main body is more convenient for a user to perform recognition, the protective groove may be recognized only by touching, such that the electronic key may be quickly found, and the convenience of the mobile phone case during use is further improved. Moreover, the side, away from the containing groove of the electronic key is flush with the protective groove, such that the electronic key may be protected by the protective groove, the electronic key is prevented from being damaged by external force, and a service life of the electronic key is further prolonged.
7. When the electronic key provided by the example of the present invention is clamped in the position clamping groove, the first arc-shaped chamfer is arranged at the first clamping angle, and the second arc-shaped chamfer is arranged at the second clamping angle. It may be understood that since the radius of the first arc-shaped chamfer and the radius of the second arc-shaped chamfer are different, when the first arc-shaped chamfer is placed at the second clamping angle or the second arc-shaped chamfer is placed at the first clamping angle, the electronic key fails to be clamped in the position clamping groove, and therefore, the uniqueness of mounting orientation of the electronic key is ensured by setting the arc-shaped chamfers with different radii, reverse mounting of the electronic key is avoided, and dismounting and mounting by the user are facilitated.
8. Detachable connection is achieved between the electronic key and the position clamping groove which are provided by the example of the present invention in a magnetic attraction manner, the magnetic member and the magnetic attraction member are simple in structure, high in interchangeability and convenient to machine and manufacture, and later maintenance and replacement are facilitated.
9. The electronic key provided by the example of the present invention is any one of the electronic vehicle key, the electric door key and the electronic lock key, and the user may select different types of electronic keys according to specific use conditions, thereby further improving selectivity of the electronic key in the mobile phone case.

The above-mentioned are merely preferred examples of the present invention, and are not intended to limit the present invention. Any modifications, equivalent replacements and improvements made within the principle of the present invention should fall within the protection scope of the present invention.

What is claimed is:

1. A mobile phone case having an electronic key, comprising a case main body and the electronic key, wherein a containing groove for containing a mobile phone is provided in one side of the case main body, a position clamping groove matching the electronic key is provided in a bottom plate of the containing groove, and the electronic key is detachably embedded in the position clamping groove.

2. The mobile phone case according to claim 1, wherein one of the electronic key and the position clamping groove is provided with a clamping convex eave, the other of the electronic key and the position clamping groove is provided with a clamping groove corresponding to the clamping convex eave in position and matching the clamping convex eave, and the electronic key is in clamping connection to the position clamping groove by means of the clamping convex eave and the clamping groove.

3. The mobile phone case according to claim 1, wherein the position clamping groove penetrates the case main body, the electronic key is further provided with a control button, and the control button is arranged on the side away from the containing groove.

4. The mobile phone case according to claim 1, wherein a depth of the position clamping groove is greater than or equal to a thickness of the electronic key.

5. The mobile phone case according to claim 4, wherein the side, away from the containing groove, of the electronic key is flush with the side, away from the containing groove, of the position clamping groove.

6. The mobile phone case according to claim 4, wherein the side, away from the containing groove, of the position clamping groove is further provided with a rib, the rib protrudes from the case main body and is arranged in an enclosed manner to form a protective groove, and the side, away from the containing groove, of the electronic key is flush with the protective groove.

7. The mobile phone case according to claim 2, wherein the electronic key is further provided with a fool-proof device, and the fool-proof device cooperates with the position clamping groove to prevent reverse mounting of the electronic key.

8. The mobile phone case according to claim 7, wherein two opposite sides of the clamping convex eave are provided with a first arc-shaped chamfer and a second arc-shaped chamfer with different radii respectively, the clamping groove is further provided with a first clamping angle corresponding to the first arc-shaped chamfer and a second clamping angle corresponding to the second arc-shaped chamfer, and when the electronic key is clamped in the position clamping groove, the first arc-shaped chamfer is arranged at the first clamping angle, and the second arc-shaped chamfer is arranged at the second clamping angle.

9. The mobile phone case according to claim 1, wherein the electronic key is further provided with a magnetic attraction member, the position clamping groove is further provided with a magnetic member corresponding to the magnetic attraction member, and the electronic key is in magnetic attraction connection to the position clamping groove by means of the magnetic attraction member and the magnetic member.

10. The mobile phone case according to claim 1, wherein the electronic key is any one of an electronic vehicle key, an electric door key, and an electronic lock key.
